(19) United States
(12) Patent Application Publication
(10) Pub. No.: US 2017/0373938 A1
(43) Pub. Date: Dec. 28, 2017

(54) PREDICTIVE AUTO-SCALING OF VIRTUALIZED NETWORK FUNCTIONS FOR A NETWORK

(71) Applicant: Alcatel-Lucent USA Inc., Murray Hill, NJ (US)

(72) Inventors: Helmut Raether, Shorewood, IL (US); Ranjan Sharma, New Albany, OH (US)

(21) Appl. No.: 15/194,469

(22) Filed: Jun. 27, 2016

(51) Int. Cl. H04L 12/24

(52) U.S. Cl. CPC H04L 41/0886; H04L 41/147; H04L 41/0816; H04L 41/12

(57) ABSTRACT

Systems, methods, and software for auto-scaling Virtualized Network Functions (VNF) in a network. In one embodiment, an adaptive engine stores initial rules for a set of auto-scaling rules. The adaptive engine monitors behavior of the network operator in scaling a VNF in response to events, and generates learned rules for the set of auto-scaling rules based on the behavior of the network operator. The adaptive engine adjusts a sequence of the initial rules and the learned rules in the set of auto-scaling rules. The adaptive engine predicts a future event in the network that will activate scaling of the VNF, and auto-scales the VNF for the network based on the set of auto-scaling rules before occurrence of the future event.

### FIELD OF THE INVENTION

The invention is related to the field of communication systems and, in particular, to networks that provide network functions.

### BACKGROUND

Service providers have traditionally implemented a physical network architecture to deploy network functions, such as routers, switches, gateways, servers, etc. For example, network functions were traditionally deployed as physical devices, where software was tightly coupled with the proprietary hardware. These physical network functions have to be manually installed into the network, which creates operational challenges and prevents rapid deployment of new network functions. To address these issues, service providers are turning to a virtualized network architecture, which is referred to as Network Functions Virtualization (NFV). In NFV, a Virtualized Network Function (VNF) is the implementation of a network function using software that is decoupled from the underlying hardware. A VNF may include one or more virtual machines (VM) running software and processes on top of servers, switches, storage, a cloud computing infrastructure, etc., instead of having dedicated hardware appliances for each network function.

The use of VNFs comes with several management considerations. If resources (e.g., compute, storage, network, etc.) of the virtualized architecture become overloaded, new resources may be deployed as needed. For example, an orchestration layer may deploy one or more new VMs to add capacity to the system. Presently, growth and de-growth are reactive in nature and contingent upon arriving at some trigger point (such as measurements taken that show resource usage beyond the engineered limits, or critical alarms that state loss of system functionality in part or whole). Reactive procedures are often inefficient, and service providers are looking for better ways of managing a network architecture.

### SUMMARY

Embodiments described herein provide predictive auto-scaling of VNFs of a network. Instead of having a network operator react to an event in the network and scale the VNFs to manage the event, the embodiments described herein predict when an event is about to occur, and automatically scale one or more of the VNFs to avert the event from occurring. Therefore, management of the network is handled in a more efficient manner.

One embodiment comprises an adaptive engine configured to auto-scale a VNF for a network of a network operator based on a set of auto-scaling rules. The adaptive engine comprises a storage device that stores initial rules for the set of auto-scaling rules. The adaptive engine also includes a processor that implements a learning module that monitors behavior of the network operator in scaling the VNF in response to events, and generates learned rules for the set of auto-scaling rules based on the behavior of the network operator. The processor of the adaptive engine implements a prioritizing module that adjusts a sequence of the initial rules and the learned rules in the set of auto-scaling rules. The processor of the adaptive engine implements a predicting module that predicts a future event in the network that will activate scaling of the VNF, and auto-scales the VNF for the network based on the set of auto-scaling rules before occurrence of the future event.

In another embodiment, each rule in the set of auto-scaling rules includes a trigger for scaling the VNF, and one or more actions to perform in response to the trigger to scale the VNF.

In another embodiment, the processor of the adaptive engine further implements a validating module that validates one or more of the initial rules based on the behavior of the network operator. A weighted value is assigned to each rule in the set of auto-scaling rules indicating a validity of its associated rule.

In another embodiment, the validating module increases the weighted value of an initial rule based on the number of times that the initial rule was executed by the network operator.

In another embodiment, the validating module validates the initial rule(s) when behavior of the network operator indicates that the network operator follows the action(s) in response to the trigger.

In another embodiment, the predicting module assigns an upper hysteresis value to each rule in the set of auto-scaling rules, predicts the future event that will trigger a scale-up or scale-out of the VNF when the upper hysteresis value is reached, and performs the action(s) in response to the upper hysteresis value being reached.

In another embodiment, the predicting module assigns a lower hysteresis value to each rule in the set of auto-scaling rules, predicts the future event that will trigger a scale-down or scale-in of the VNF when the lower hysteresis value is reached, and performs the action(s) in reverse in response to the lower hysteresis value being reached.

In another embodiment, the processor of the adaptive engine implements an adapting module that modifies the set of auto-scaling rules based on the behavior of the network operator.

In another embodiment, the prioritizing module orders the sequence of the initial rules and the learned rules in the set of auto-scaling rules based on a preference of the network operator and/or network conditions.

Another embodiment comprises a method for auto-scaling a VNF for a network of a network operator based on a set of auto-scaling rules. The method includes storing initial rules for the set of auto-scaling rules, monitoring behavior of the network operator in scaling the VNF in response to events, and generating learned rules for the set of auto-scaling rules based on the behavior of the network operator. The method further includes adjusting a sequence of the initial rules and the learned rules in the set of auto-scaling rules. The method further includes predicting a future event in the network that will activate scaling of the VNF, and auto-scaling the VNF for the network based on the set of auto-scaling rules before occurrence of the future event.

Another embodiment comprises a non-transitory computer readable medium embodying programmed instructions executed by a processor to implement an adaptive engine that auto-scales a VNF for a network of a network operator based on a set of auto-scaling rules. The instructions direct the processor to store initial rules for the set of auto-scaling rules. The instructions direct the processor to implement a learning module that monitors behavior of the network operator in scaling the VNF in response to events, and generates learned rules for the set of auto-scaling rules based on the behavior of the network operator. The instructions direct the processor to implement a prioritizing module that adjusts a sequence of the initial rules and the learned rules in the set of auto-scaling rules. The instructions direct the processor to implement a predicting module that predicts a future event in the network that will activate scaling of the VNF, and auto-scales the VNF for the network based on the set of auto-scaling rules before occurrence of the future event.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a network architecture in the prior art.

FIG. 2 illustrates an adaptive engine in an exemplary embodiment.

FIG. 3 illustrates a network architecture in an exemplary embodiment.

FIG. 4 is a flow chart illustrating a method of predictive auto-scaling for one or more VNFs in an exemplary embodiment.

FIG. 5 illustrates a set of auto-scaling rules in an exemplary embodiment.

FIG. 6 illustrates a set of auto-scaling rules with learned rules added in an exemplary embodiment.

FIG. 7 illustrates a set of auto-scaling rules with initial rules validated in an exemplary embodiment.

FIG. 8 illustrates a set of auto-scaling rules with an adjusted sequence in an exemplary embodiment.

FIG. 9 illustrates a set of auto-scaling rules with a modified rule in an exemplary embodiment.

FIG. 10 illustrates a set of auto-scaling rules with hysteresis values in an exemplary embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

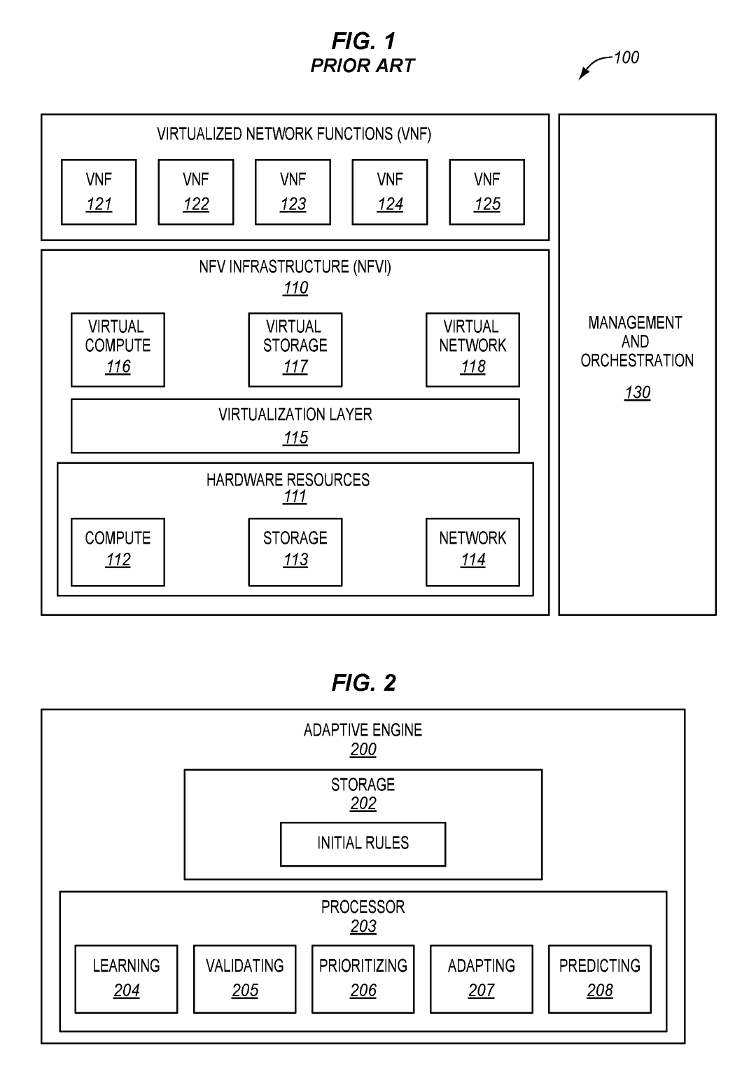

FIG. 1 illustrates a network architecture 100 in the prior art. Network architecture 100 uses NFV, which is a concept that virtualizes classes of network node functions into building blocks that may connect or chain together to create communication services. Architecture 100 includes an NFV infrastructure 110, which includes hardware resources 111, such as compute resources 112, storage resources 113, and network resources 114. NFV infrastructure 110 also includes a virtualization layer 115, which is able to create virtual compute resources 116, virtual storage resources 117, and virtual network resources 118.

Architecture 100 also includes Virtualized Network Functions (VNFs) 121-125. Each VNF 121-125 may comprise one or more virtual machines (VM) running different software and processes on top of NFV infrastructure 110. A VM is an operating system or application environment that is installed on software which imitates dedicated hardware. Specialized software called a hypervisor emulates a CPU, memory, hard disk, network, and/or other hardware resources, which allows the virtual machines to share the hardware resources. Each VNF 121-125 in the embodiments described herein perform one or more network functions. A network function is a “well-defined functional behavior” within a network, such as firewalling, domain name service (DNS), caching, network address translation (NAT), etc. Individual VNFs may be linked or chained (i.e., service chaining) together in a way similar to building blocks to offer a full-scale networking communication service.

Architecture 100 also includes management and orchestration layer 130. Management and orchestration layer 130 provides for planned automation and provisioning tasks within the virtualized environment. The tasks of orchestration include configuration management of compute resources 112, storage resources 113, and network resources 114. The tasks of orchestration also include provisioning of VMs and application instances, such as for VNFs 121-125. The tasks of orchestration may also include security and compliance assessment, monitoring, and reporting.

In the embodiments described herein, predictive auto-scaling is performed to scale-up or scale-out individual VNFs or a group of VNFs, or to scale-down or scale-in individual VNFs or a group of VNFs. A scale-up refers to deploying more resources (e.g., CPU, memory, hard disk, and network) for one or more VNFs, while scale-out refers to adding more nodes to the system. A scale-down refers to decreasing resources for one or more VNFs, while scale-in refers to reducing the number of nodes used in the system. An adaptive engine is described that predicts impending events that trigger auto-scaling to engage, performs the auto-scaling, measures the auto-scaling efficiency during overloads, and adapts its behavior for future events. FIG. 2 illustrates an adaptive engine 200 in an exemplary embodiment. Adaptive engine 200 may be implemented in network architecture 100 as shown in FIG. 1, such as in management and orchestration layer 130, or may be implemented in any network architecture. Adaptive engine 200 includes a storage device 202 that is pre-provisioned with initial rules for auto-scaling. Adaptive engine 200 includes a processor 203 that implements a learning module 204, a validating module 205, a prioritizing module 206, an adapting module 207, and a predicting module 208. Learning module 204 is configured to actively learn the behavior of a network operator in managing a network, and generate learned rules from the behavior. Validating module 205 is configured to validate the initial rules based on the behavior of a network operator in managing a network. Prioritization module 206 is configured to adjust the sequence of the initial rules and the learned rules. Adapting module 207 is configured to modify the initial rules and/or the learned rules based on more complex network behavior. Predicting module 208 is configured to predict the auto-scaling needs within a network based on the initial rules and/or the learned rules. A further description of adaptive engine 200 is provided below.

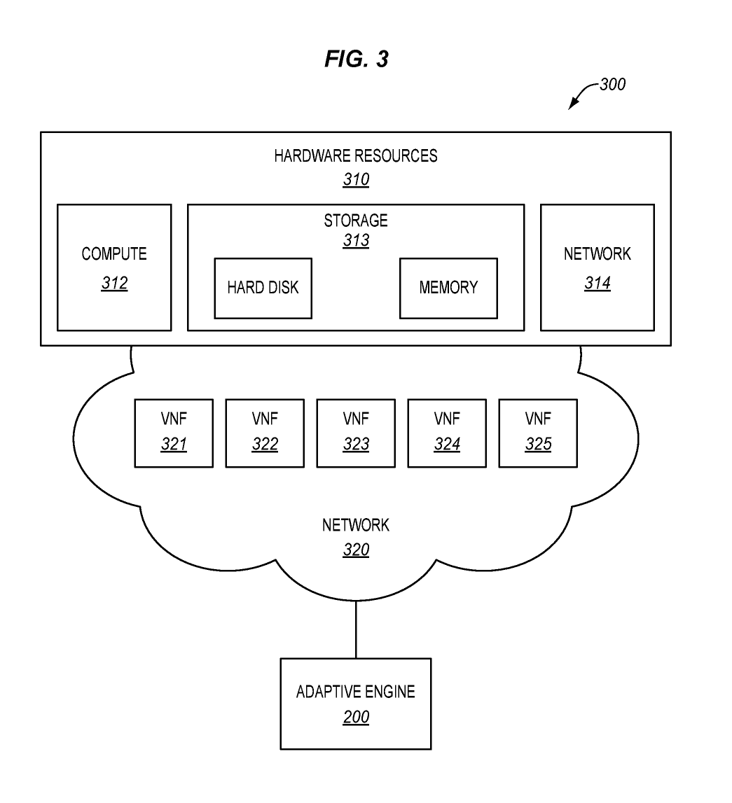

FIG. 3 illustrates a network architecture 300 in an exemplary embodiment. Network architecture 300 includes hardware resources 310 that include compute resources 312, storage resources 313 (including hard disk and memory), and network resources 314, although other hardware resources may be utilized. A network operator uses these resources to form a network 320, which is comprised of a plurality of VNFs 321-325 that perform network functions within network 320. The network operator also uses adaptive engine 200 as described herein to manage the resources of network 320. For example, if more resources are needed to perform a network function, then adaptive engine 200 is used to scale-up or scale-out one or more VNFs 321-325 that perform the network function. Adaptive engine 200 may deploy more compute resources 312, storage resources 313, network resources 314, etc., to scale-up the VNFs 321-325. If fewer resources are needed to perform a network function, then adaptive engine 200 is used to scale-down one or more VNFs 321-325 that perform the network function. Adaptive engine 200 may reduce compute resources 312, storage resources 313, network resources 314, etc., to scale-down the VNFs 321-325.

Instead of reacting to an event occurring within network 320 that requires scaling of one or more VNFs 321-325, adaptive engine 200 predicts when an event will occur within network 320, and automatically scales (auto-scale) one or more VNFs 321-325. This concept is referred to as predictive auto-scaling. Adaptive engine 200 is proactive in scaling the VNFs 321-325 to avert problems in providing the network functions.

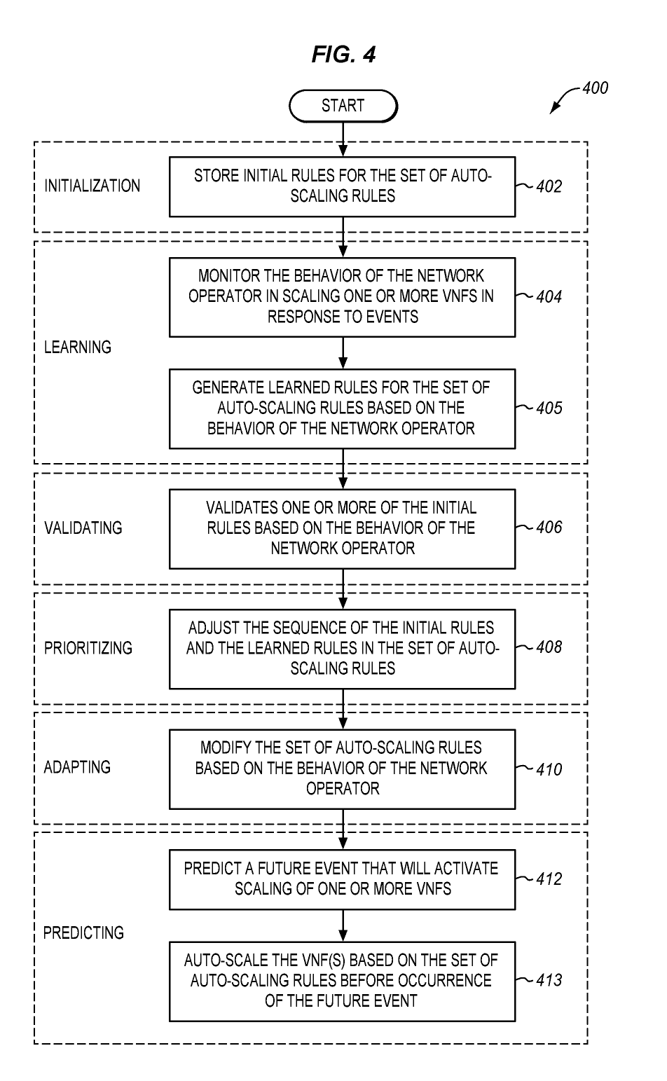

FIG. 4 is a flow chart illustrating a method 400 of predictive auto-scaling for one or more VNFs 321-325 in an exemplary embodiment. The steps of method 400 will be described with reference to network architecture 300 in FIG. 3, but those skilled in the art will appreciate that method 400 may be performed in other systems or architectures. Also, the steps of the flow charts described herein are not all inclusive and may include other steps not shown, and the steps may be performed in an alternative order.

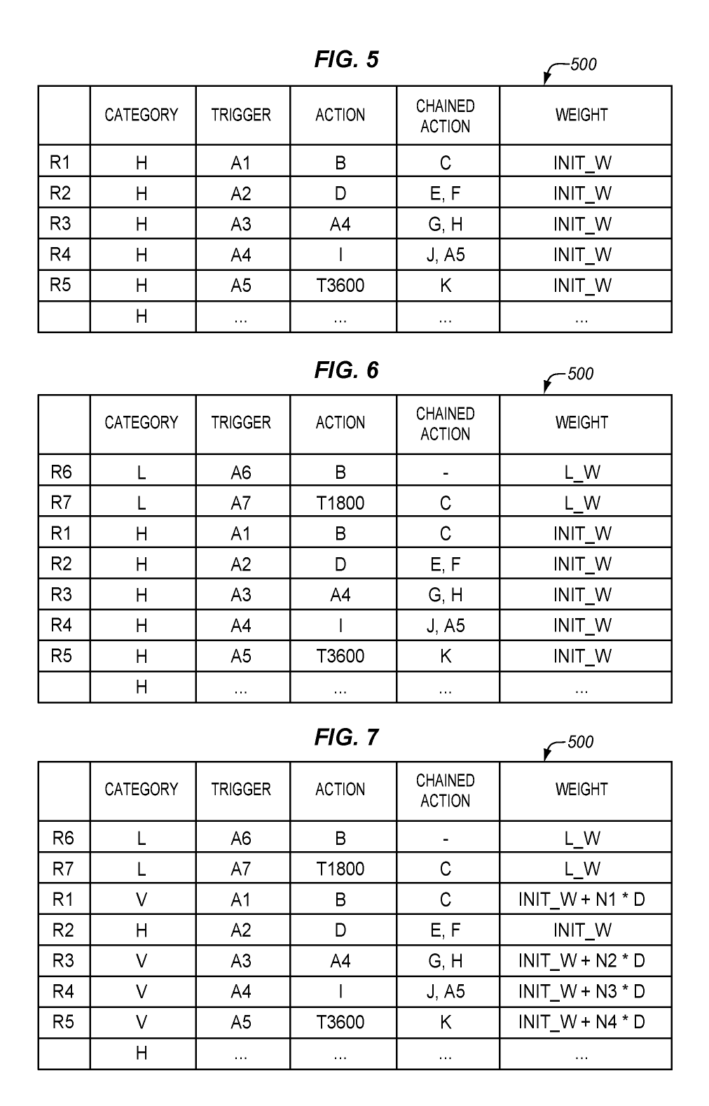

The steps of method 400 may be described as phases of predictive auto-scaling. Step 402 represents an initialization phase, where initial rules for auto-scaling are pre-loaded onto adaptive engine 200 and stored in a storage device 202 (see FIG. 2). Adaptive engine 200 operates based on a set of auto-scaling rules, which are rules that are defined for auto-scaling one or more VNFs 321-325 for network 320. For the auto-scaling rules in the initialization phase, adaptive engine 200 is pre-provisioned with initial rules. The initial rules are defined by the network operator, such as to address traditional scaling needs in a network. With adaptive engine 200 seeded with the initial rules, adaptive engine 200 may observe actions performed by the network operator for a number of events that trigger scaling of VNFs 321-325. A trigger may be a specific date, a day each year, a network condition typified by resource usage, network delays, etc. FIG. 5 illustrates a set of auto-scaling rules 500 in an exemplary embodiment. The format of the set of auto-scaling rules 500 as indicated herein is just an example, and may vary as desired. Each rule includes a trigger followed by one or more actions to perform in response to the trigger. For example, the initial rules may include:

H: If trigger A1 occurs, then perform action B followed by action C;

H: If trigger A2 occurs, then perform actions D, E, and F in sequence;

H: If trigger A3 occurs, then execute trigger A4 and perform actions G and H;

H: If trigger A4 occurs, then perform actions I and J and then execute trigger A5;

H: If trigger A5 occurs, then wait 3600 seconds and perform action K.

The initial rules may be preceded by an “H:” or another indicator to connote that these are initially provisioned in adaptive engine 200. The set of auto-scaling rules 500 may also be assigned a weighted value that is used to indicate the validity of the rules. The initial rules may be assigned an initial weight indicated as “Init_w”. Adaptive engine 200 may perform a defensive check on the initial rules to ensure that they will not have an adverse impact on the VNF.

Steps 404-405 of FIG. 4 represent a learning phase, where adaptive engine 200 actively learns the behavior of the network operator. Adaptive engine 200 (through learning module 204 of FIG. 2) monitors behavior of the network operator in scaling one or more VNFs 321-325 in response to events (step 404), and generates learned rules for the set of auto-scaling rules 500 based on the behavior of the network operator (step 405). Adaptive engine 200 may not perform any scaling operations in the learning phase. Because adaptive engine 200 receives Key Performance Indices (KPI) for network 320, it is able to observe the behavior of the network operator based on the values of the indices. If specific indices are not “seeded” in the initial rules, then adaptive engine 200 is able to add to the set of auto-scaling rules 500 based on the operator behavior. For example, if adaptive engine 200 observes that the network operator performs an action in response to a specific trigger that was not defined in the initial rules, then adaptive engine 200 may generate a new “learned” rule. FIG. 6 illustrates the set of auto-scaling rules 500 with learned rules added in an exemplary embodiment. In observing the behavior of the network operator, adaptive engine 200 may generate rules such as:

L: If trigger A6 occurs, then perform action B;

L: If trigger A7 occurs, then wait 1800 seconds and perform action C.

The learned rules may be preceded by an “L:” or another indicator to connote that these are rules learned by adaptive engine 200. Adaptive engine 200 may also assign a weighted value indicated by “L_W” to the learned rules. The rank of the learned rules is expected to be higher than “Init_W”, since “L_W” is based on learning in network 320. At this point, the ordering of the set of auto-scaling rules 500 may change based on rank or weight of the rules. Also, the rules in category “H:” may maintain the same rank as before, or may be validated in the learning phase. The learning phase may continue to further refine and augment the set of auto-scaling rules 500 in time.

Further, a reaction time may be set while adaptive engine 200 observes behavior of the network operator in performing an action in response to a specific trigger. For instance, if condition “x” generates reaction “y” by the network operator within time “t”, then adaptive engine 200 may be considered a valid learned rule. If the reaction “y” occurs after time “t”, then there probably there is no correlation between trigger “x” and reaction “y”. Therefore, adaptive engine 200 may not generate a learned rule.

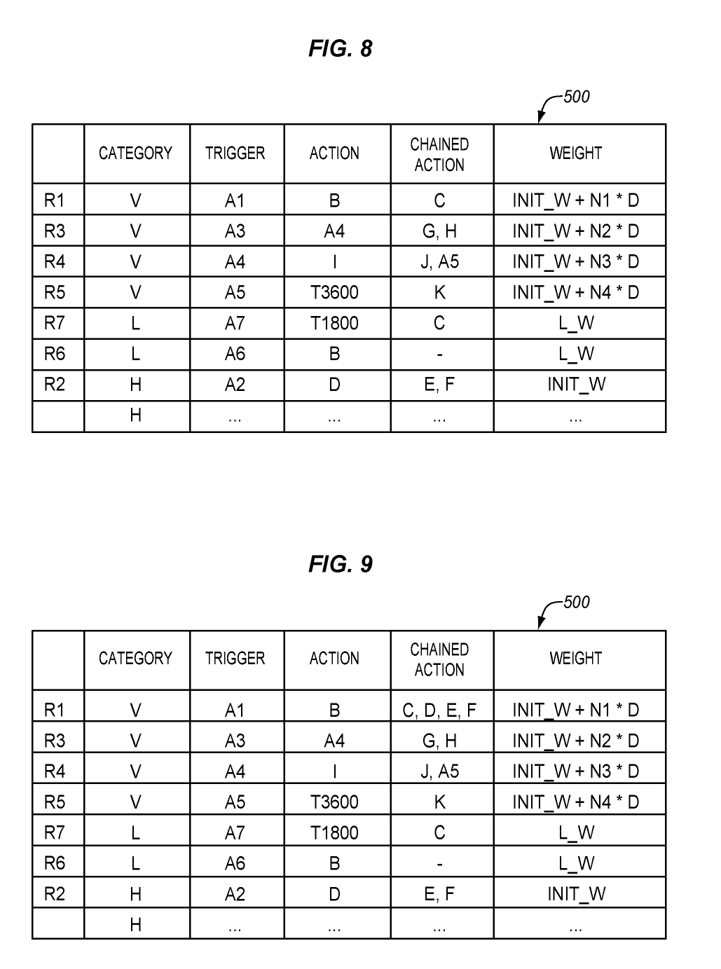

Step 406 of FIG. 4 represents a validating phase (optional), where adaptive engine 200 validates the initial rules based on the behavior of the network operator. Adaptive engine 200 (through validating module 205 of FIG. 2) monitors the behavior of the network operator in scaling one or more VNFs 321-325 in response to the events (step 404), and validates one or more of the initial rules based on the behavior of the network operator (step 406). As triggers occur in network 320, adaptive engine 200 is able to validate one or more of the initial rules as pre-provisioned by the network operator. A validation of a rule means that adaptive engine 200 observes that the network operator follows the expected set of actions in the sequence as defined in an initial rule in response to a trigger. It is not expected that all of the initial rules will be validated within a short period of time. However, with growth in subscriber and usage traffic, the trigger base may be completely tested and validated. When validating the initial rules, adaptive engine 200 may annotate the rules with a “V:”. FIG. 7 illustrates the set of auto-scaling rules 500 with initial rules validated in an exemplary embodiment. During or after validation, the set of auto-scaling rules 500 may be as follows:

V: If trigger A1 occurs, then perform action B followed by action C;

H: If trigger A2 occurs, then perform actions D, E, and F in sequence;

V: If trigger A3 occurs, then execute trigger A4 and perform actions G and H;

V: If trigger A4 occurs, then perform actions I and J and then execute trigger A5;

V: If trigger A5 occurs, then wait 3600 seconds and perform action K;

L: If trigger A6 occurs, then perform action B;

L: If trigger A7 occurs, then wait 1800 seconds and perform action C.

Assume for example that adaptive engine 200 determines (e.g., based on the KPI) that trigger A1 has occurred. If adaptive engine 200 identifies that the network operator performs action B followed by action C in response to trigger A1, then adaptive engine 200 is able to validate this initial rule. Validation is performed on the initial rules in the set of auto-scaling rules 500. The learned rules are considered auto-validated, as adaptive engine 200 has already observed triggers and associated operator actions.

Adaptive engine 200 may also modify the weighted values of the initial rules that are validated in step 406. Adaptive engine 200 may increase the weighted values of an initial rule based on the number of times that the initial rule was executed by the network operator. For example, adaptive engine 200 may take the initial weight, and add a delta (D) multiplied by the number of times (N1) that an initial rule was executed by the network operator (Init W+N1*D).

Step 408 of FIG. 4 represents a prioritizing phase, where adaptive engine 200 (through prioritizing module 206 in FIG. 2) adjusts the sequence of the initial rules and the learned rules in the set of auto-scaling rules 500. There may be instances where an initial rule does not match a learned rule. In other cases, more than one trigger may apply. For instance, if auto-scaling is predicated on a specific date as well as a network condition, both conditions may apply simultaneously but auto-scaling once would suffice. The extent of auto-scaling required by the two rules is considered, and the network operator may choose to exercise the more defensive option. In this phase, the sequence of the initial rules and the learned rules may be modified based on operator preference, network conditions, etc. FIG. 8 illustrates the set of auto-scaling rules 500 with an adjusted sequence in an exemplary embodiment. The set of auto-scaling rules 500 may be as follows:

V: If trigger A1 occurs, then perform action B followed by action C;

V: If trigger A3 occurs, then execute trigger A4 and perform actions G and H;

V: If trigger A4 occurs, then perform actions I and J and then execute trigger A5;

V: If trigger A5 occurs, then wait 3600 seconds and perform action K;

L: If trigger A7 occurs, then wait 1800 seconds and perform action C.

L: If trigger A6 occurs, then perform action B;

H: If trigger A2 occurs, then perform actions D, E, and F in sequence.

In this example, the priorities for triggers A6 and A7 are swapped. The sequence of the rules indicates the order in which adaptive engine 200 will evaluate their associated triggers. The evaluation of the set of auto-scaling rules 500 starts from the top. The initial rules that were not validated during the learning or validation phases drop to the end of the sequence. When validated, these initial rules may climb up in the ordered list of execution, as their associated weights increase for each occurrence.

Step 410 of FIG. 4 represents an adapting phase, where adaptive engine 200 may modify the set of auto-scaling rules 500 to learn more complex network behavior. Adaptive engine 200 (through adapting module 207 in FIG. 2) monitors behavior of the network operator (step 404), and modifies the set of auto-scaling rules 500 (either the initial rules or the learned rules) based on the behavior of the network operator (step 410). For instance, if the actions within a rule are not sufficient to control network conditions, then the list may be augmented in this phase. For example, adaptive engine 200 may observe that when trigger A1 occurs, it is invariably followed by trigger A2 and thus executing the actions B, C, D, E, and F in sequence. Therefore, adaptive engine 200 may combine rule R1 with rule R2 so that rule R1 is now:

V: If trigger A1 occurs, then perform action B, followed by actions C, D, E, F.

FIG. 9 illustrates the set of auto-scaling rules 500 with a modified rule in an exemplary embodiment. This phase is expected to be a slow phase, and changes in the set of auto-scaling rules 500 may not occur rapidly.

Steps 412-413 of FIG. 4 represent a predicting phase, where adaptive engine 200 predicts the auto-scaling needs within network 320. Adaptive engine 200 (through predicting module 208 in FIG. 2) predicts a future event that will activate scaling of one or more VNFs 321-325 (step 412), and auto-scales the VNF(s) 321-325 based on the set of auto-scaling rules 500 before occurrence of the future event (step 413). With a validated and tested rule set in its repository, adaptive engine 200 may now use the set of auto-scaling rules 500 to scale-up or scale-down one or more VNFs 321-325 in network 320. In order to predict the scaling needs, adaptive engine 200 may assign hysteresis values (H_value) to the set of auto-scaling rules 500 so that it may anticipate a resource demand before actually hitting the critical threshold. A hysteresis value is a percentage or fraction of the trigger for a rule. For example, if a rule has a trigger A1, then a hysteresis value may be a 90% value of trigger A1. There may be multiple hysteresis values assigned to each rule. An upper hysteresis value may be assigned to a rule to scale-up (or scale-out, as necessary) a VNF, and a lower hysteresis value may be assigned to a rule to scale-down (or scale-in) a VNF.

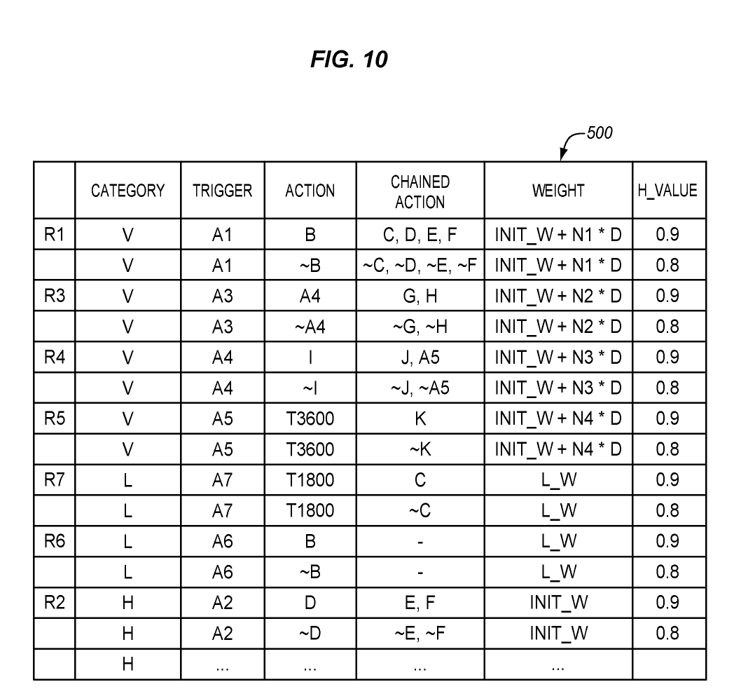

FIG. 10 illustrates the set of auto-scaling rules 500 with hysteresis values in an exemplary embodiment. In this example, rule R1 has been assigned an upper hysteresis value of 90% and a lower hysteresis value of 80%. When a 90% value for trigger A1 is reached, adaptive engine 200 initiates actions B, C, D, E, and F in that sequence. When the measured value (single or composite) for trigger A1 falls to 80% of its critical threshold, adaptive engine 200 initiates de-scaling by reversing the routines B through F (indicated by ˜B . . . ˜F). These are complementary routines and perform actions which are opposite to those performed in the original B . . . F routines.

Adaptive engine 200 continually scales-up or scales-down the VNFs 321-325 in network 320 as needed to provide the network functions. Because adaptive engine 200 is predicting when events occur, it is able to scale-up a VNF 321-325 before a critical situation is reached so that network functions are not hindered. Adaptive engine 200 is also able to scale-down a VNF 321-325 as needed to return resources to an available pool. Adaptive engine 200 also continually learns from the actions taken in response to certain triggers so that it can more effectively manage network 320.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the disclosure is not limited to those specific embodiments. The scope of the disclosure is defined by the following claims and any equivalents thereof.

We claim:

1. A system comprising:
an adaptive engine configured to auto-scale a Virtualized Network Function (VNF) for a network of a network operator based on a set of auto-scaling rules, the adaptive engine comprising:
a storage device that stores initial rules for the set of auto-scaling rules; and
a processor that implements:
a learning module that monitors behavior of the network operator in scaling the VNF in response to events, and generates learned rules for the set of auto-scaling rules based on the behavior of the network operator;
a prioritizing module that adjusts a sequence of the initial rules and the learned rules in the set of auto-scaling rules; and
a predicting module that predicts a future event in the network that will activate scaling of the VNF, and auto-scales the VNF for the network based on the set of auto-scaling rules before occurrence of the future event.

2. The system of claim 1 wherein:
each rule in the set of auto-scaling rules includes:
a trigger for scaling the VNF; and
at least one action to perform in response to the trigger to scale the VNF.

3. The system of claim 2 further comprising:
a validating module that validates at least one of the initial rules based on the behavior of the network operator;
wherein a weighted value is assigned to each rule in the set of auto-scaling rules indicating a validity of its associated rule.

4. The system of claim 3 wherein:
the validating module increases the weighted value of an initial rule based on the number of times that the initial rule was executed by the network operator.

5. The system of claim 3 wherein:
the validating module validates the at least one initial rule when behavior of the network operator indicates that the network operator follows the at least one action in response to the trigger.

6. The system of claim 2 wherein:
the predicting module assigns an upper hysteresis value to each rule in the set of auto-scaling rules, predicts the future event that will trigger a scale-up or scale-out of the VNF when the upper hysteresis value is reached, and performs the at least one action in response to the upper hysteresis value being reached.

7. The system of claim 2 wherein:
the predicting module assigns a lower hysteresis value to each rule in the set of auto-scaling rules, predicts the future event that will trigger a scale-down or scale-in of the VNF when the lower hysteresis value is reached, and performs the at least one action in reverse in response to the lower hysteresis value being reached.

8. The system of claim 1 wherein the processor further implements:
an adapting module that modifies the set of auto-scaling rules based on the behavior of the network operator.

9. The system of claim 1 wherein:
the prioritizing module orders the sequence of the initial rules and the learned rules in the set of auto-scaling rules based on at least one of a preference of the network operator and network conditions.

10. A method for auto-scaling a Virtualized Network Function (VNF) for a network of a network operator based on a set of auto-scaling rules, the method comprising:
storing initial rules for the set of auto-scaling rules;
monitoring behavior of the network operator in scaling the VNF in response to events;
generating learned rules for the set of auto-scaling rules based on the behavior of the network operator;
adjusting a sequence of the initial rules and the learned rules in the set of auto-scaling rules;
predicting a future event in the network that will activate scaling of the VNF; and
auto-scaling the VNF for the network based on the set of auto-scaling rules before occurrence of the future event.

11. The method of claim 10 wherein:
each rule in the set of auto-scaling rules includes:
a trigger for scaling the VNF; and
at least one action to perform in response to the trigger to scale the VNF.

12. The method of claim 11 further comprising:
validating at least one of the initial rules based on the behavior of the network operator;
wherein a weighted value is assigned to each rule in the set of auto-scaling rules indicating a validity of its associated rule.

13. The method of claim 12 further comprising:
increasing the weighted value of an initial rule based on the number of times that the initial rule was executed by the network operator.

14. The method of claim 12 wherein:
validating the at least one of the initial rules based on the behavior of the network operator comprises validating the at least one initial rule when behavior of the network operator indicates that the network operator follows the at least one action in response to the trigger.

15. The method of claim 11 further comprising:
assigning an upper hysteresis value to each rule in the set of auto-scaling rules;
wherein predicting the future event in the network that will activate scaling of the VNF comprises predicting the future event that will trigger a scale-up or scale-out of the VNF when the upper hysteresis value is reached; and
wherein auto-scaling the VNF comprises performing the at least one action in response to the upper hysteresis value being reached.

16. The method of claim 11 further comprising:
assigning a lower hysteresis value to each rule in the set of auto-scaling rules;
wherein predicting the future event in the network that will activate scaling of the VNF comprises predicting the future event that will trigger a scale-down or scale-in of the VNF when the lower hysteresis value is reached; and
wherein auto-scaling the VNF comprises performing the at least one action in reverse in response to the lower hysteresis value being reached.

17. A non-transitory computer readable medium embodying programmed instructions executed by a processor to implement an adaptive engine that auto-scales a Virtualized Network Function (VNF) for a network of a network operator based on a set of auto-scaling rules, wherein the instructions direct the processor to:
store initial rules for the set of auto-scaling rules;
implement a learning module that monitors behavior of the network operator in scaling the VNF in response to events, and generates learned rules for the set of auto-scaling rules based on the behavior of the network operator;
implement a prioritizing module that adjusts a sequence of the initial rules and the learned rules in the set of auto-scaling rules; and
implement a predicting module that predicts a future event in the network that will activate scaling of the VNF, and auto-scales the VNF for the network based on the set of auto-scaling rules before occurrence of the future event.

18. The computer readable medium of claim 17 wherein:
each rule in the set of auto-scaling rules includes:
a trigger for scaling the VNF; and
at least one action to perform in response to the trigger to scale the VNF.

19. The computer readable medium of claim 18 wherein the instructions direct the processor to:
implement a validating module validates at least one of the initial rules based on the behavior of the network operator;
wherein a weighted value is assigned to each rule in the set of auto-scaling rules indicating a validity of its associated rule.

20. The computer readable medium of claim 19 wherein:
the validating module increases the weighted value of an initial rule based on the number of times that the initial rule was executed by the network operator.
